(19) United States
(12) Patent Application Publication
(10) Pub. No.: US 2010/0012542 A1
(43) Pub. Date: Jan. 21, 2010

(54) Tamper Indicator Device

(76) Inventor: Ray Methuen, Gwent (GB)

Correspondence Address: WINSTEAD PC, P.O. BOX 50784, DALLAS, TX, 75201, US

(21) Appl. No.: 12/300,080

(22) PCT Filed: May 8, 2007
(86) PCT No.: PCT/GB07/01681

§ 371 Date: Jun. 8, 2009

(30) Foreign Application Priority Data
May 8, 2006 (GB) 0609118.5

(51) Int. Cl. B65D 55/02; B42D 15/00

(52) U.S. Cl. 206/459.1; 283/72

(57) ABSTRACT

A tamper-indicator device (10) for engagement with an item, such device comprising at least two substantially parallel members (12,14) which produce visible mark when brought into contact with one another under pressure, the device including means (16) for causing relative movement of the parallel members such that at least a portion of the visible mark is erased.

### BACKGROUND TO THE INVENTION

The present invention relates to a device for items such as containers and the like to allow the detection of tampering of the container or the like, for example, during storage or transit.

It is important in many areas to be able to determine if an item such as a container has been tampered with and thus, if the possibility exists that the contents of the container have been tampered with. For example, it is important to be able to determine-if medication or foodstuff containers have been tampered with between their point of manufacture and their use by the consumer. In addition, there are situations where securing of the contents of a container, such as a box or briefcase or the like, is of concern. There is also the possibility where safety considerations make the ability to detect tampering of fundamental importance, for example, in the case of the storage of classified drugs or of sensitive documents, or the transit and processing of hazardous waste and the like.

Although there are many examples of devices, such as seals and the like, which may be applied to containers and other similar items that, if broken, indicate that tampering may have taken place, due to their method of operation, such devices may not be used more than once. Thus, although any attempt to break into the container may be detected as it results in the destruction of the device or seal, by their very nature, such devices are only appropriate for single use. A fresh device needs to be fitted each time the container is opened and then closed again in order that constant monitoring for tampering may be undertaken. This can be an expensive way to ensure the integrity of a container's contents, particularly where the container is opened many times during the life of the container and/or the container contents.

In addition, the situation exists where the constant reapplication of a fresh single-use tamper-indicator device is not practical, such as for medication bottles in a hospital or supervised environment. Thus, such medication bottles tend to be left unsealed once opened and held in a locked room when not in use. However, this does not ensure that there has been no unauthorised opening of the container during the time the container is removed from the locked room. As the container is unlikely to be constantly supervised during this time, any tampering with the container or its contents would go undetected.

There is therefore a need in the art for a device to indicate whether any tampering has occurred to a container, such a device being simple to apply, and optionally re-usable in environments where repeated use of such a device may be desirable.

A further situation exists where patients must be given medication at a specific time or times on a daily basis. Occasionally hospital staff or carers are distracted and fail to administer the required dose at the required time. Where the medication is self-administered, the patient, particularly if elderly or infirm, can often become confused and fail to take their medication at the appropriate time or perhaps forget that they have already taken their medication and self-administer a further dose. Omission or duplication of doses of medication can have serious medical consequences for the patient.

Many devices or receptacles are available that act as reminders to take medication, but typically these devices are not incorporated into the original packaging of the medication. Therefore, pills and the like have to be placed into these devices or receptacles before use. The possibility exists that, once separated from their original packaging, pills could be mixed up and that the resulting errors could cause significant harm to the patient.

There is therefore a need in the art for a device that is incorporated into the original medication packaging that can serve as a reminder to take a pill or provide an indication of a missed dose and that is reusable and adds little extra cost or complexity to the packaging.

### SUMMARY OF THE INVENTION

The present invention seeks to address the problems of the prior art.

Accordingly, a first aspect of the present invention provides a tamper-indicator device for engagement with an item, such device comprising at least two substantially parallel members which produce a visible mark when brought into contact with one another under pressure, the device including means for causing relative movement of the at least two parallel members such that at least a portion of the visible mark is erased.

The term ‘relative movement’ is intended to include relative movement causing a spatial separation between the parallel members, as well as any movement causing a displacement of the parallel members within the plane of their contacting surfaces whether or not the relative movement causes spatial separation of the parallel members relative to one another. In addition, the term ‘relative movement’ is intended to cover any other form of relative movement possible between the parallel members which is suitable to cause erasure of at least a portion of the visible mark.

The item may be any article which is capable of a first and second configuration, such as an open and closed configuration. Such items include, but are not limited to, bottles, containers, briefcases, suitcases, cabinets, boxes, and the like.

In this way, a visible mark may be applied to the device when the item is in a secure or closed configuration, the visible mark remaining until such time as the items is opened, thus resulting in relative movement of the parallel members and erasure of at least a portion of the visible mark.

Prior art tamper indicators are often implemented using seals and the like that are removed or broken in order to gain access to an item. In this way, evidence of access to an item is apparent. The removal of a seal is equivalent to removal of information. A seal that is intact provides the information that the item has not been accessed and a seal that is broken or removed provides information that access has occurred.

However, whereas a seal once removed cannot be reapplied, the present invention allows the removal of information when an item is opened, but enables re-use when the item is returned to a closed state.

Many prior art devices have the properties that information can be recorded, erased and reused. These devices can generally be described as erasable marking mediums and include for example, blackboards, whiteboards, magnetic drawing boards, electronic writing pads, and the like.

By providing a means of information erasure in respect of an erasable reusable marking medium providing access to an item, it is possible to provide a reusable tamper-indicating device. As the device can record information it is also able to display information that can be used as a reminder. By optionally providing means to prevent reuse, the device becomes a single-use tamper-indicator.

Therefore, in the situation where a device has been applied to an item, or indeed is integral with the item, and the item is in a closed or secure configuration, it will be possible to tell if the item has been tampered with by looking for the visible mark which was initially applied to the device. If the visible mark has been partially or wholly erased, this would indicate that the item has been tampered with. Should the visible mark still be present as it was initially applied to the device, then the item has not been tampered with, since any tampering with the item would result in partial or complete erasure of the visible mark.

Preferably, a surface coating is provided on at least a part of one of the parallel members interposed between the two parallel members. Such a coating aids the retention of contact between the two parallel members after pressure has been applied to bring the parallel members into contact and create a visible mark.

The coating may be a wax coating or may be any other releasably adhesive coating suitable for the purpose.

In one embodiment, the at least two parallel members are substantially planar. However, it will be appreciated that the two parallel members may be any other suitable contour, such as assuming a curve or the like.

In a further embodiment, the means for separating the parallel members comprises a frictional engagement which spatially separates the two parallel members.

The relative movement of the parallel members may comprise a sliding movement, or a rotational movement or any combination thereof or any other suitable relative movement between the two members sufficient to separate the two parallel members from one another or displace the two parallel members relative to one another, to produce partial or whole erasure of the visible marks.

Alternatively, the means for providing relative movement of the parallel members may be located between the parallel members and pass between the parallel members to separate the parallel members at the location of the visible mark. For example, the means for separating the parallel members may comprise a longitudinal spacer, or thread or wire or any other suitable structure know to the skilled person and suitable for the function.

In one embodiment, the tamper-indicator device further comprising means to prevent the at least two substantially parallel members from being brought into contact with one another under pressure after the substantially parallel members have been separated from one another.

Where means are provided to prevent the at least two substantially parallel members from being brought into contact with one anther under pressure after the parallel members have been separated, the tamper-indicator device will be a single-use device. The means of preventing the parallel members from returning into contact with one another may comprise any suitable projection or biasing member or the like which prevents at least one of the parallel members from returning to its original position where it may be brought into contact with the other parallel member under pressure so as to product a visible mark. Alternatively, a transparent or partially transparent cover may be provided over the device such that after relative movement of the parallel members to erase the whole or part of the visible marks, access to the parallel members is prevented such that no new visible mark may be applied by bringing the parallel members into contact again under pressure. The prevention of application of a visible mark to the device thereby makes the device a single-use device. The device may be opaque, transparent or partially transparent.

The relative movement of the parallel members may be operable to automatically separate the parallel members when the device is removed from the item.

It will be appreciated that the means for inducing relative movement of the parallel members may be automatically operable such that no manual input from a user is involved. Alternatively, the means for inducing relative movement of the parallel members may be manually operated.

In a tamper-indicator device according to any aspect of the present invention, the item may be a container such as a pill container, or the like. Where this is the case, the device may be integral with the closure member of the item.

Alternatively, where the item is a bottle for example, or any other container which will require regular cleaning, the tamper-indicator device may be provided as a separate device to the container, rather than being provided integrally with the container. This allows the container and device to be separated so that the container may undergo rigorous cleaning and/or maintenance. In addition, should the container have a particularly long useful life such as a filing cabinet or the like, the separate provision of the tamper-indicator device will allow multiple replacement devices to be used with the same container over time.

A further aspect of the present invention provides an indicator device for an item, the device comprising an erasable marking medium and an engagement portion for engaging with a container, the engagement portion having an engaged position and an unengaged position, and the medium being arranged such that in the unengaged position of the engagement portion, the medium is at least partially erased of marks.

In one embodiment, the erasable marking medium comprises a pair of substantially parallel substantially planar members which product a visible mark when brought into contact with one another, the unengaged position of the engagement portion causing the members to be moved relative to one another, thereby erasing any such visible marks.

In any aspect of the present invention, the visible mark may be produced by bringing the parallel members into contact with one another under pressure using any suitable implement, including but not limited to, a stylus or writing implement such as a pen or pencil, a pointed stick, a finger-nail, a stamping device provided in relief or any other suitable item for applying pressure to bring the substantially parallel members into contact with one another.

For example, if a stamp is used, the stamp could be provided with a particular securing code and/or symbol, such stamps being provided to authorised personnel only. In this way, should a container be tampered with, the container then closed and a further visible mark created by applying pressure to bring the two parallel members into contact with one another again, by an unauthorised individual, without the security stamp, the visible mark produced will not resemble the visible mark originally applied to the device. Thus, tampering of the container will be apparent.

Alternatively, rather than using a security stamp, an identification mark such as a signature, date and time of access and/or any other relevant information could be applied to the device as the visible mark for the purposes of tamper detection.

The same information could also serve as an aid to memory that, for example, an item was last accessed at a particular date or time or that a particular person was the last to have access.

In one embodiment, the device further comprises a cover, such as a removable cover located so as to prevent access to the parallel members when the cover is in place.

The cover may be transparent or opaque. Where the cover is transparent, the device would be protected from possible damage during transit or storage and the user would be able to see the manufacturer's stamp prior to opening.

An opaque cover could be printed with a mark and the same mark could be stamped on the erasable device. The user would be able to open the item and expect the erasable surface to have the same marking as the cover. Alternatively, the cover could be printed with information such as identification information or the like, while still allowing visibility of the underlying parallel member. Such a cover would continue to protect the device from damage during transit or storage.

Both types of cover could be used to not only cover the erasable device, but also to seal the container. In such an embodiment, the cover could be provided with a seal which would need to be broken initially to obtain access to the container. This would provide dual evidence of initial tampering, but not prevent re-use.

A further aspect of the present invention provides a method of applying a tamper-indication to an item, the method comprising the steps of:
i. providing a tamper-indicator device according to any preceding Claim;
ii. applying the device to an item; and
iii. applying a mark to the device by bringing the two parallel members together under pressure.

A further aspect of the present invention provides a method of detecting tampering of an item on which the method of the preceding aspect of the present invention has been carried, said method of detecting comprising checking if the mark applied at step iii above is present on the device, the absence of the mark indicating that tampering has taken place.

Alternatively, the presence of the mark may indicate that no tampering has taken place.

A further aspect of the present invention provides a security stamp for use with a tamper-indicator device according to a preceding aspect of the present invention, such a stamp comprising a defined pattern provided in relief for use in the application of pressure to the surface of the device, and in particular to the surface of the first parallel member, either directly or indirectly.

### BRIEF DESCRIPTION OF THE DRAWINGS

An embodiment of the invention will now be described, by way of example only, and with reference to the accompanying drawings, in which:

FIG. 1 is a perspective view of a first embodiment of a tamper-indicator device according to a first aspect of the present invention;

FIG. 1A is a perspective view of a further embodiment of a tamper-indicator device according to a first aspect of the present invention;

FIG. 2 is a plan view of a second embodiment of a tamper-indicator device according to a first aspect of the present invention when fitted to a container (not shown);

FIG. 3 is a plan view of the embodiment of FIG. 2 after removal from the container (not shown);

FIG. 4 is a cross-sectional view of a further embodiment of a tamper-indicator device according to a first aspect of the present invention when fitted to a container;

FIG. 5 is a cross-sectional view of the embodiment of FIG. 4 after removal from the container;

FIG. 6 is a cross-sectional view of a further embodiment of a tamper-indicator device according to a first aspect of the present invention when fitted to a container;

FIG. 7 is a cross-sectional view of the embodiment of FIG. 6 after removal from the container;

FIG. 8 is a cross-sectional view of a further embodiment of a tamper-indicator device according to a first aspect of the present invention when fitted to a container;

FIG. 9 is a cross-sectional view of the embodiment of FIG. 8 after removal from the container;

FIG. 10 is a plan view of a container incorporating a further embodiment of a tamper-indicator device according to a first aspect of the present invention;

FIG. 11 is a view of the container of FIG. 10 through section A-A (shown in FIG. 10);

FIG. 11A is an enlarged view of a selected portion of FIG. 11;

FIG. 12 is a view of the container of FIG. 10 in an open configuration with one side wall of lid 7 removed at section A-A of FIG. 10;

FIG. 13 is a side view of the container of FIG. 10 in a closed configuration and with a portion of lid 7 removed at section B-B of FIG. 10;

FIG. 14 is a plan view of a further embodiment of a tamper-indicator device according to a first aspect of the present invention;

FIG. 15 is a view of the embodiment of FIG. 14 through section A-A (shown in FIG. 14);

FIG. 16 is a plan view of the embodiment of FIG. 14 in an open configuration;

FIG. 17 is a view of the embodiment of FIG. 16 through section A-A (shown in FIG. 16).

FIG. 18 is a cross-sectional view of a container incorporating the embodiment of FIG. 15;

FIG. 19 is a plan view of a container incorporating a further embodiment of a tamper-indicator device in accordance with a first aspect of the present invention;

FIG. 20 is a view of the container of FIG. 19 through section A-A (shown in FIG. 19);

FIG. 21 is a perspective view of a container incorporating a further embodiment of a tamper-indicator device in accordance with a first aspect of the present invention;

FIG. 22 is a plan view of the container of FIG. 21;

FIG. 23 is a sectional view through A-A of FIG. 22 with the opening flap of the container in a closed configuration;

FIG. 24 is a sectional view through B-B of FIG. 22;

FIG. 25 is a sectional view of the container of FIG. 22 corresponding to the view of FIG. 23, but with the opening flap of the container in an open configuration;

FIG. 26 is a cross-sectional view of a further embodiment of a single-use tamper-indicator device in accordance with a first aspect of the invention shown secured to a container;

FIG. 27 is a cross-sectional view of the embodiment of FIG. 26 shown partially removed from the container relative to the container;

FIG. 28 is a cross-sectional view of the embodiment of FIG. 26 completely removed from the container;

FIG. 29 is a perspective view of a container incorporating a further embodiment of a tamper-indicator device in accordance with a first aspect of the present invention;

FIG. 30 is a sectional view of FIG. 29 with the container in the closed configuration;

FIG. 30A is an enlargement of a portion of FIG. 30;

FIG. 31 is a sectional view of FIG. 29 with the container in the open configuration;

FIG. 31A is an enlargement of a portion of FIG. 31; and

FIG. 32 is an exploded view of FIG. 29

### DETAILED DESCRIPTION OF THE INVENTION

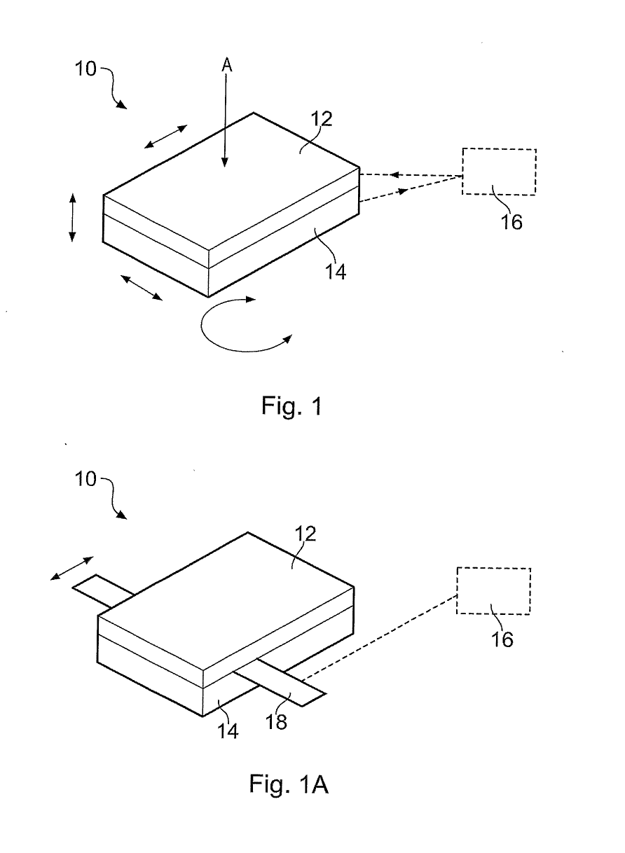

FIG. 1 shows a tamper-indicator device 10 comprising first and second parallel members 12, 14 which are substantially planar in form. Actuator 16 is represented by dotted lines and could comprise, for example, a container closure member or the closure member opening mechanism or a closure member locking device, or any suitable part of the container closure system which moves as the container changes between closed and open configurations. Operation of actuator 16 causes relative movement of the first and second parallel members 12, 14. It will be appreciated that this relative movement may be in any of the directions or combination of directions shown by the arrows in FIG. 1.

In use, pressure is applied to one side of first parallel member 12 as shown by arrow A in FIG. 1, the pressure being applied bringing the first and second parallel members 12, 14 into contact with one another and resulting in a visible mark appearing on first parallel member 12 corresponding to the area of first parallel member 12 to which pressure was applied. Operation of actuator 16 to induce relative movement between first and second parallel members 12, 14, serves to produce relative movement between the first and second parallel members 12, 14 thus resulting in partial or complete erasure of the visible mark. This erasure of previously recorded information is indicative of operation of actuator 16 and thus indicative that the container has been opened or at least tampered with.

This is the basic concept which is applied to many of the aspects of the present invention.

FIG. 1A shows a tamper-indicator device 10, with first and second parallel members 12, 14. An actuator 16 is provided in communication with an intermediate member 18 located between the first and second parallel members 12, 14. As described with reference to FIG. 1, a visible mark is applied to the tamper-indicator device 10 by application of pressure to one side of first parallel member 12. Should actuator 16 be moved, as would be the case if the container were opened, the actuator 16 would cause movement of intermediate member 18, thereby causing intermediate member 18 to pass between the first and second parallel members 12, 14, resulting in their partial or complete separation from one another. This separation of the first and second parallel members 12, 14 results in erasure of the whole or part of the previously applied visible mark, i.e. recorded information. This erasure of the recorded information indicates that the container has been opened, and therefore if such opening was unauthorised, tampering may have taken place.

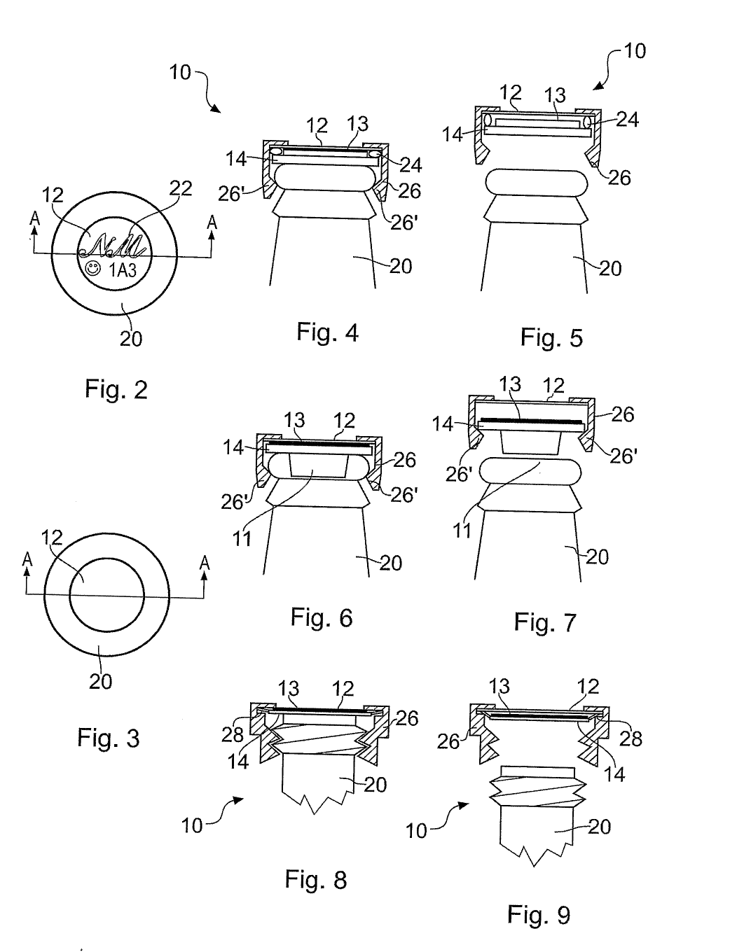

FIG. 2 is a plan view of a tamper-indicator device 10 when fitted to a container 20 such as a jar or bottle. Engagement member 26 is provided for engaging the neck of the container, by means of abutments 26′ provided around the engagement member 26. First and second parallel members 12, 14 are provided at the upper edge of engagement member 26 as shown in FIG. 4, and coating 13 is provided on one side of second parallel member 14 adjacent first parallel member 12. The coating 13 may comprise any suitable material, but is preferably a wax or adhesive coating, such as a releasable adhesive coating, which makes contact with the surface of first parallel member 12 when force is applied to the surface of first parallel member 12, thereby creating a visible mark where pressure has been applied, as shown in FIG. 2. As can be seen in FIG. 3, when the two parallel members are separated the visible mark is erased.

As can be seen in FIG. 4, a resilient member 24 is provided as a spacer between second parallel member 13 and the upper lip of engagement member 26. When engagement member 26 is closed around the opening of container 20, resilient member 24, which typically comprises a seal or any other suitable plastic or rubber material, becomes compressed such that application of pressure to the surface of first parallel member 12 will result in parallel members 12, 14 making contact with one another and creation of a visible mark 22 (see FIG. 2) on the surface of first parallel member 12.

As can be seen in FIG. 5, when the engagement member is disengaged from the container 20 and the tamper-indicator device 10 is removed from container 20, resilient member 24 is no longer compressed between second parallel member 14 and the upper edge of engagement member 26, and thus resilient member 24 reassumes its non-compressed shape. This results in separation of first and second parallel members 12, 14, and thus results in the erasure of visible mark 22 from the surface of first parallel member 12.

Thus, it can be seen that the tamper-indicator device 10 may be used as shown in FIGS. 4 and 5 for attachment to a container 20 by means of engagement member 26. Once in close engagement with container 20, pressure may be applied to first parallel member 12 to create a visible mark 22. Visible mark 22 is then erase on removal of the tamper-indicator device 10 from container 20 as first and second parallel members 12, 14 are separated when resilient member 24 reassumes its non-compressed shape.

FIGS. 6 and 7 show a further embodiment of a tamper-indicator device 10 for use with a container 20 in accordance with a first aspect of the present invention. FIG. 6 shows the tamper-indicator device 10 with a bung portion 11 in close engagement with the neck of a container 20 and FIG. 7 shows the tamper-indicator device 10 removed from container 20. As can be seen in FIG. 6, when engagement member 26 is engaged with the opening of container 20, first and second parallel members 12, 14 are adjacent one another such that pressure applied to the surface of first parallel member 12 will result in the creation of a visible mark 22 at the surface of first parallel member 12. However, as seen in FIG. 7, when the tamper-indicator device 10 is removed from container 20, pressure applied in the upwards direction to the device to remove it from the neck of container 20 coupled with resistance against removal of the device caused by frictional engagement between bung 11 and the neck of container 20 results in separation of the two parallel members. Second parallel member 14 then drops into engagement with abutment 26′ provided on engagement member 26. The separation of the two parallel members has the effect of erasure of visible mark 22 from the surface of first parallel member 12.

Similarly, FIGS. 8 and 9 show a further embodiment of a tamper-indicator device 10 for use at the opening of a container 20 in the engaged and non-engaged positions respectively. In the tamper-indicator device 10 of FIGS. 8 and 9, second parallel member 14 is provided with a flexible rim member 28. When tamper-indicator device 10 is brought into engagement with the opening of container 20, first and second parallel members 12, 14 are brought adjacent one another against the biasing of flexible rim member 28 of second parallel member 14, such that application of pressure to the surface of first parallel member 12 results in the creation of visible mark 22. When the tamper-indicator device 10 is removed from inter-engagement with the opening of container 20, as shown in FIG. 9, first and second parallel members 12, 14 are urged apart under bias of flexible rim member 28 of second parallel member 14, thus erasing visible mark 22 from the surface of first parallel member 12.

Although the embodiment of FIGS. 4 to 7 involves a push-fit engagement between engagement member 26 of tamper-indicator device 10 and container 20, and FIGS. 8 and 9 involve a threaded fit between the engagement member 26 and container 20, either type of engagement may be used with any of the embodiments described simply by modifying the configuration of engagement member 26.

It will be appreciated that the embodiments described in FIGS. 4 to 9 may be of particular use in determining if unattended drinks bottles and the like have been tampered with. In addition, the tamper-indicator device 10 may be simply adapted for use with glasses and the like, provided that the engagement member is dimensioned and adapted to grip the rim of the glass.

Where the tamper-indicator device 10 is intended for use in areas of poor lighting, such as discos and bars, it may be advantageous to incorporate a photosensitive component into the composition of first parallel member 12 or coating 13 so that viewing of the surface of first parallel member 12 (and thus any visible mark 22) may be improved under the ultraviolet lighting often used in such environments.

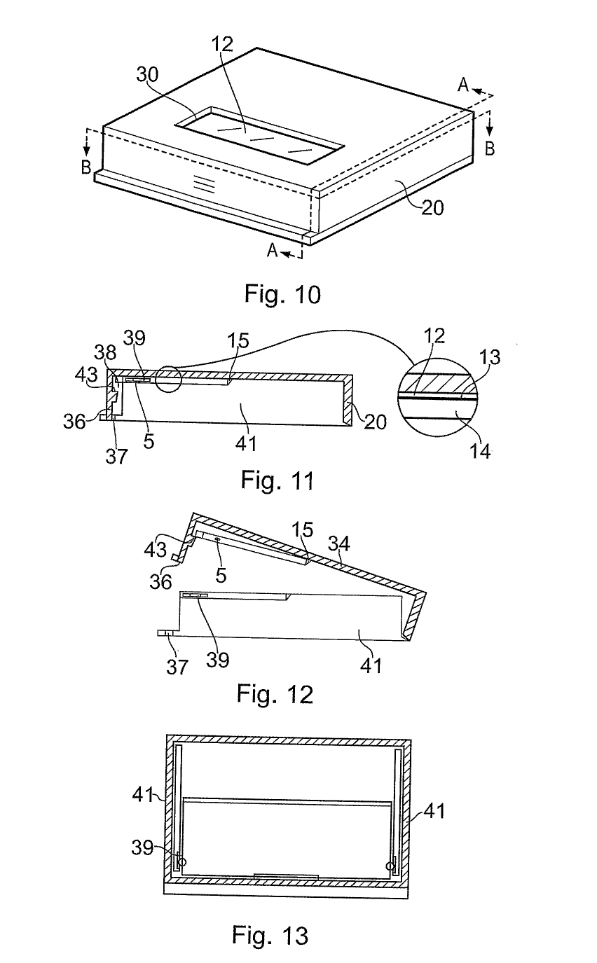

FIG. 10 shows a perspective view of a further embodiment of a tamper-indicator device 10 in accordance with a first aspect of the present invention. Container 20 is shown, for the purposes of illustration, as a box-type container and is provided with an aperture 30 in the upper surface of container lid 34 through which the surface of first parallel member 12 is visible.

FIG. 11 shows a sectional view through A-A of FIG. 10 with the container lid 34 shown in a closed configuration. FIG. 12 shows a sectional view through A-A of FIG. 10 with the container lid 34 in an open configuration.

As can be seen in FIGS. 10 to 13, container lid 34 is pivotable between an open and a closed configuration and in FIG. 11 is shown held in a closed configuration by means of catch 36 which is received within an aperture 37 within the base of container 20. The side edges of second parallel member 14 have protrusions 5 that are engaged with recesses 39 of sidewalls 41 of container 20 First and second parallel members 12 and 14 are in contact thus pressure may be applied to the surface of first parallel member 12 through aperture 30 in container lid 34 so as to create a visible mark 22 at the surface of first parallel member 12.

However, as shown in FIG. 12, when the container lid 34 initially assumes an open configuration, after releasing catch 36, parallel member 14 is retained by protrusions 5 in the recesses 39 of sidewalls 41 of container 20.

Parallel member 14 is joined to the underside of lid 34 by hinge 15 so as the lid 34 is opened the end of parallel member 12 opposite hinge 15 hinges downward separating the contact between parallel members 12,14 thereby erasing the visible mark which had been created at the surface of first parallel member 12. Further opening of lid 34 causes abutment 43 to contact the lower edge of parallel member 14. This causes sidewalls 8 to spring slightly apart releasing protrusions 5 from recesses 41. Parallel member 14 is thus retained in container lid 34. Subsequent closure of lid 34 reverses the process described so enabling the surface of parallel member 12 to receive further marks by the application of pressure.

The embodiment described in FIGS. 10 to 13 may be particularly useful in the security of classified drugs or medication or the like where it is important to determine if any tampering has taken place either during storage or transit, the first and second parallel members 12, 14 and aperture 30 in container lid 34 being of suitable dimension to receive any relevant recorded information and/or any security authorisation codes or symbols.

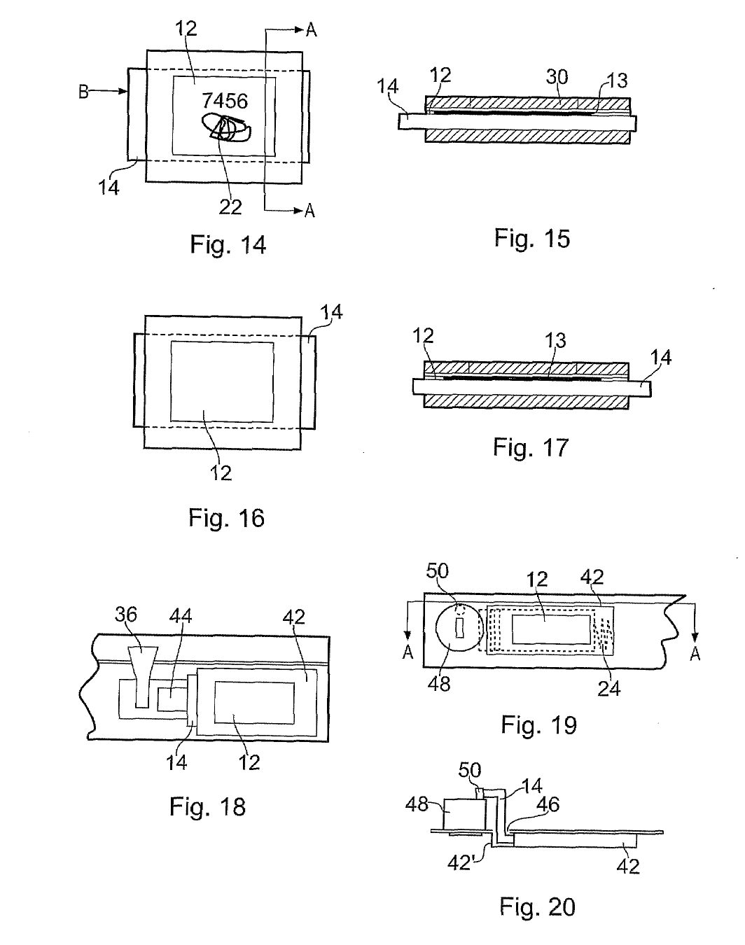

FIGS. 14 to 17 show a further embodiment of the present invention where erasure of the visible mark 22 occurs by a sliding action produced by the movement of opening of the container 20. Container 20 is shown, for the purposes of illustration as a briefcase in FIG. 18 and a filing cabinet in FIG. 20. Housing 42 of container 20 is provided with an aperture through which second parallel member 14 and thus also coating 13 can freely slide. First parallel member 12 is attached, to the inside of the upper surface edging of housing 12 and is accessible through aperture 30 in housing 42 of container 20. As shown in FIGS. 14 and 15, when the container is in a closed position, first parallel member 12 assumes a particular position relative to second parallel member 14, and first and second parallel members 12, 14 are adjacent one another such that application of pressure to the surface of first parallel member 12 through aperture 30 in container 20 results in the creation of a visible mark 22.

FIGS. 16 and 17 show the tamper-indicator device 10 when the container 20 to which the device is attached is in an open configuration. During the movement from a closed to an open configuration, second parallel member 14 is moved through the slot in housing 42 of container 20. However, as first parallel member 12 is held stationery, this movement of second parallel member 14 results in relative movement between the two parallel members 12, 14, resulting in erasure of visible mark 22 from the surface of parallel member 12 as the contact points between first and second parallel members 12, 14 have become displaced.

To re-use the tamper-indicator device 10, the second parallel member is simply slipped back through the slot in housing 42 of container 20 to its original position and pressure applied to the surface of first parallel member 12 through aperture 30 of container 20 to produce a further visible mark 22.

FIGS. 18 to 20 illustrate possible implementations of the concept of the embodiment described in relation to FIGS. 14 to 17.

FIG. 18 shows an embodiment of a tamper-indicator device 10 according to the present invention shown in conjunction with a locking mechanism commonly used with containers 20 such as suitcases and briefcases. When the container is closed, second parallel member 14 is moved manually until it is touching or in close proximity to the release button 44 of catch 36. Pressure may now be applied to the surface of first parallel member 12 to create a visible mark 22 at the surface of first parallel member 12.

When the container 20 is moved into an open configuration, release button 44 is moved towards the tamper-indicator device 10 which is fixed to the body of container 20. This causes movement of second parallel member 14 through the housing 42 of container 20, thereby causing relative movement between first and second parallel members 12, 14, resulting in erasure of visible mark 22 from the surface of first parallel member 12.

FIG. 19 shows a further variation in which a tamper-indicator device 10 is used in conjunction with a lock of the type commonly used on filing cabinets and the like. FIG. 20 shows a sectional view through A-A of FIGS. 19.

The tamper-indicator device 10 is fixed to the outer surface of the container 20 i.e. filing cabinet or the like, close to the locking mechanism and preferably close to the top of the container 20.

Second parallel member 14 has been extended at one end first backwards and then sideways so as to fit through an aperture 46 in the container 20 and is covered by an extension 42′ of housing 42. The extended end of second parallel member 14 is in close proximity to the rear of the locking device 48. The locking device 48 has a Cam 50 which rotates when the locking device 48 is opened or closed. The housing 42 has a closed end and a resilient member 24 is provided between the closed end and the edge of the second parallel member, thus forcing the second parallel member towards the locking device 48. In this position, the first and second parallel members 12, 14 are located adjacent one another and pressure may be applied to the first parallel member 12 to create a visible mark 22 at the surface of first parallel member 12.

When the locking device 48 is operated, cam 50 makes contact with the edge of second parallel member 14 moving it in a direction away from locking device 48 through housing 42 against the force of resilient member 24. This results in separation of the first and second parallel members by means of a sliding movement between the two members, thus erasing visible mark 22.

It will be appreciated that resilient member 24 could be omitted from the arrangement shown in FIGS. 19 and 20 and the second parallel member 14 allowed to simply slide through the housing 42. In such an embodiment, manual action would be required prior to re-use of the tamper-indicator device 10 in association with the container 20.

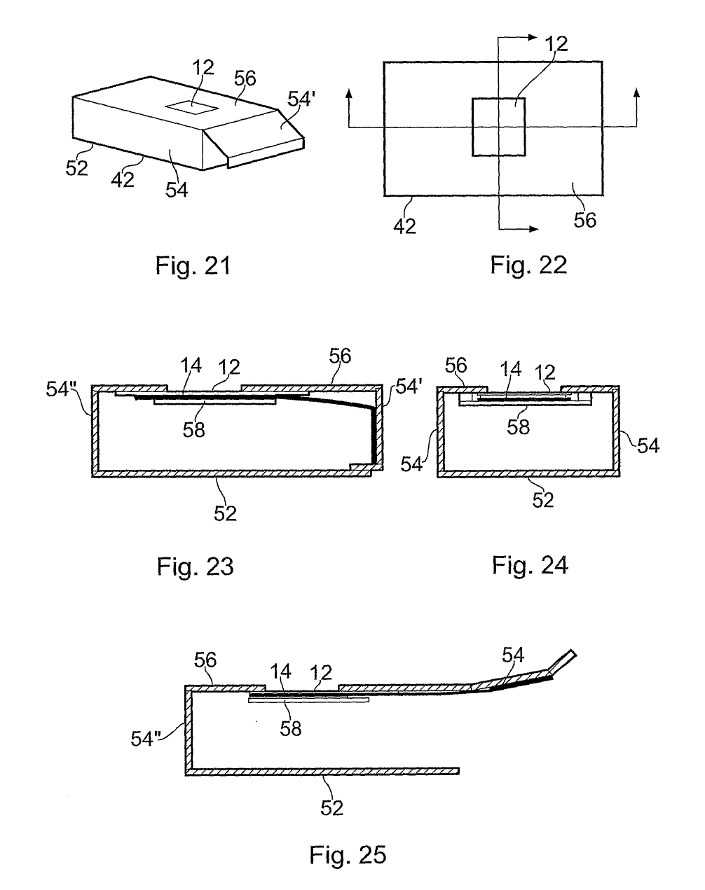

FIGS. 21 to 25 show a further embodiment of a device 10 according to the present invention used as part of a box-like container. The container comprises a housing 42 having a base wall 52, side walls 54 and an upper wall 56, one of the side walls 54′ being movable relative to the remainder of the housing 42 such that access is provided to the interior of housing 42.

The upper wall 56 is provided with an aperture therein through which the first parallel member 12 of device 10 is visible. As can be seen in FIGS. 23 to 25, device 10 comprises a first parallel member 12 and a support member 58 with a second parallel member 14 provided there between.

The second parallel member 14 extends outwards to the side wall 54′ and then downwards towards base wall 52, and is anchored at a lower portion of side wall 54′.

Thus, in use, information may be provided in the form of a visible mark at the surface of first parallel member 12 by application of force to the surface of first parallel member 12, as previously described. This mark will remain visible until such time as a user opens the container by moving side wall 54′ in a direction away from base wall 52 and opposing side wall 54″. When side wall 54″ is moved relative to the remaining walls of the container as described, second parallel member 14 is pulled in a direction towards side wall 54′ at a lower portion of side wall 54′. The relative movement between the first and second parallel members 12, 14 results in erasure of the visible mark.

When the container is closed again, by returning side wall 54′ to a position parallel to opposing wall 54″, it will be appreciated that a new mark may be applied to first parallel member 12, as previously described. In this way, the provision of information may be updated over time.

For example, if such a container were to be used for containing medication, a user would be able to add information to the first parallel member relating to the time and/or date at which the last medication was taken. Thus, a confused user would be able to tell when they last took their medication by looking at the information and would then know whether they were due to take another dose. In addition, such a system would help assist a confused user who may have forgotten that they have already taken their medication to avoid taking a further dose.

Each time the container is opened to remove medication, the information would be deleted and on closing the container the user could simply apply the date and/or time to the first parallel member 12 as previously described, as a reminder of when the last dose of medication was taken.

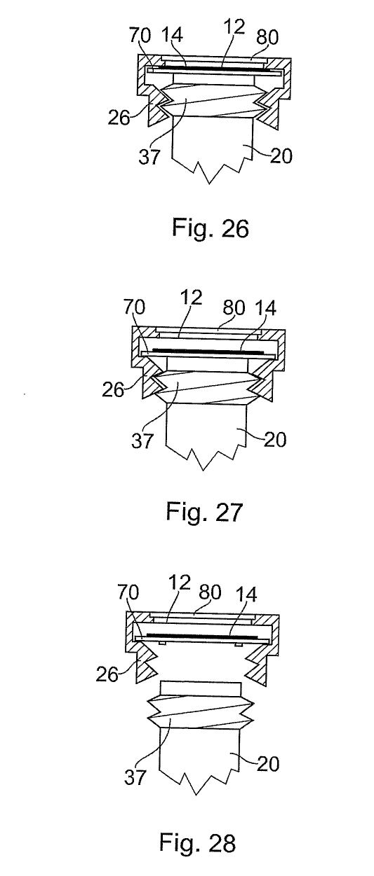

FIGS. 26 to 28 show a further embodiment of a device in accordance with the present invention.

FIG. 26 shows device 10 provided with a first parallel member 12 and a second parallel member 14, located adjacent first parallel member 12 when the device is fitted to a container 20. A protective cover 80 is provided above first parallel member 12 to protect first parallel member 12 during transit and/or storage.

Second parallel member 14 is supported on support 70. The underside edges of support 70 have an adhesive coating and so adhere to the top of the container 20 neck. A visible mark may be applied to first parallel member 12 by application of pressure to the surface of first parallel member 12 when the device is fitted to a container as shown in FIG. 26.

Device 10 is further provided with an engagement member 26 in fitted engagement with container 20, the engagement member being provided with abutments capable of complementary inter-engagement with the conformation of the neck of a container designed with a thread for example, a container designed for use with a screw-fit cap or the like.

The device 10 is screw-fitted to the neck of container 20 by means of thread formation 37 formed in the container neck.

FIG. 27 shows the embodiment of FIG. 26 where the device 10 has been partially removed from the neck of container 20. As the device 10 is partially unscrewed, the adherent force holding support 70 to the container neck is greater than that required to separate the two members so support 70 remains in contact with the neck of the container 20, whilst first parallel member 12 is moved upwards away from the neck of container 20. Thus, separation is effected between first parallel member 12 and second parallel member 14 supported on support 70. This separation will cause erasure of a visible mark present at first parallel member 12, as previously described. Further unscrewing of the device causes the internal device screw threads to apply upward pressure to the support 70 which breaks the adhesive bond between the lower edges of support 70 and the container neck. Support 70 is therefore retained inside the device and will reseal the container when the device is refitted.

FIG. 28 shows the device 10 fully removed from the container 20 with first and second parallel members 12, 14 spatially separation from one another.

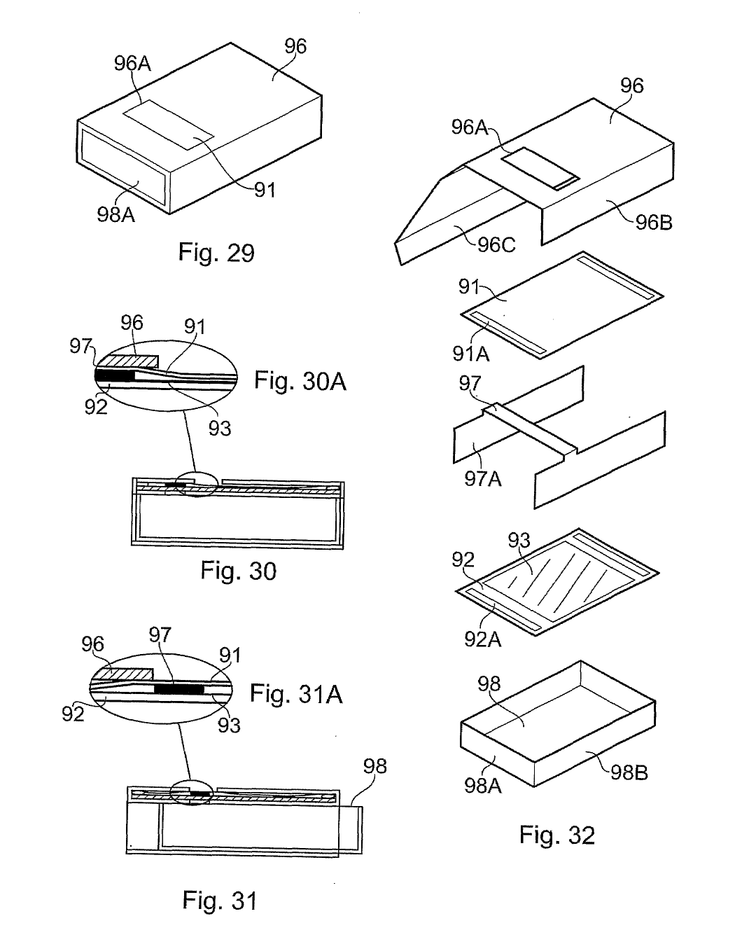

FIG. 29 shows an item that could contain blister backed pills but could also be used to contain other items. Tray 98 can slide through the outer sleeve 96 of the container when pressure is applied to tray end 98A. The surface of parallel member 1 is accessible through aperture 96A in outer sleeve 96.

FIG. 32 shows the construction of the item shown in FIG. 29. Parallel member 91 is fixed by adhesive or other means at top edges 91A to the underside top surface of outer sleeve 96. The upper surface of Parallel member 92 has a wax or releasable adhesive coating 93. and is fixed at edges 92A to the underside of parallel member 91. Sliding member 97 is thus contained but is free to move laterally between the lower surface of parallel member 91 and the upper surface of parallel member 92. Tray 98 is fixed at outer side walls 98B to the inner sides of sliding member 97 side extensions 97A Outer Sleeve 96 is wrapped around the assembly and joined by adhesive or other means at sides 96A & 96B. The resulting assembly now has the external appearance of FIG. 29.

With the container tray in the closed position shown in FIG. 29 the sliding member 97 is positioned to the side of aperture 96A as shown in sectional view 30 of FIG. 29. The parallel members 91 and 92 are adjacent to one another and pressure can be applied to the surface of parallel member 91 via aperture 96A resulting in visible marks on the upper face of parallel member 91.

When tray 98 is pushed through outer sleeve 96, attached sliding member 97 separates the parallel members 91 and 92 as shown in sectional view of FIG. 31 and results in erasure of the visible marks. FIG. 31A shows an enlarged view of a portion of the sectional view FIG. 31.

If the tray 98 is moved back to the closed position of FIGS. 29 and 30 the device may be reused.

The device could be of particular use in applications where the item is to be used to contain items of medication. Information recorded by the manufacturer could be used to verify that the device has not been previously accessed as the information is erased on opening. Following initial opening, information could be recorded such as identification of the person who accessed the device on the last occasion and could include the time, date or other information. The absence of information could indicate that the device had been accessed without authorisation. The presence of information could indicate that the device had not be accessed without authorisation and any date or time information could be used to check if a pill for example had been given at the correct time or as a reminder that medication is due.

Although aspects of the invention have been described with reference to the embodiment shown in the accompanying drawings, it is to be understood that the invention is not limited to the precise embodiment shown and that various changes and modifications may be effected without further inventive skill and effort. For example, an additional transparent plastic sheet may be provided above the surface of the first parallel member and located distal to the second parallel member in order to act as a protector for the surface of first parallel member and improve its durability. If required, the additional sheet could be incorporated into any of the embodiments described above. Alternatively, first parallel member may be a laminated member using, for example, co-extrusion techniques, in order to provide increased durability of the surface of first parallel member.

If required, a separate or alternatively integral, protective cover could be included to provide additional mechanical protection for the tamper-indicator device. Such a protective cover could be useful for briefcases and other regularly transported containers, such that the protective cover could be removed or opened to gain access to the surface of first parallel member. If desired, the whole or part of the protective cover may comprise any transparent material, thus allowing any information such as security information provided on the device below the cover to remain visible even when the cover is in place. However, if the cover is to be removed in order to gain access to first parallel member, the cover need not necessarily be transparent. The cover may be made from any suitable material such as plastic or metal or any other durable protective material known to the skilled person.

Although in the embodiments described above, where the tamper-indicator device is used in association with containers such as briefcases and filing cabinets, the tamper-indicator device is shown as a separate device to the container, it will be appreciated that the tamper-indicator device may be fitted to or incorporated into the container during initial manufacture. The device may also be used in conjunction with child resistant locking mechanisms.

1. A re-usable tamper-indicator device for engagement with an item, the device comprising at least two substantially parallel members which produce a visible mark when brought into contact with one another under pressure, and a means for causing relative movement of the parallel members such that at least a portion of the visible mark is erased.

2. A re-usable tamper-indicator device according to claim 1, wherein the at least two parallel members are substantially planar.

3. A re-usable tamper-indicator device according to claim 2, wherein the direction of relative movement occurs in the plane of the parallel members.

4. A re-usable tamper-indicator device according to claim 1, wherein the means for causing relative movement of the parallel members comprises engagement of pressure or force which spatially separates the two parallel members.

5. A re-usable tamper-indicator device according to claim 4, wherein the relative movement of the parallel members occurs by means of spatial separation of the parallel members.

6. A re-usable tamper-indicator device according to claim 4, wherein the relative movement of the parallel members occurs by means of movement without spatial separation.

7. A re-usable tamper-indicator device according to claim 1, wherein the means for relative movement between the parallel members is located between the parallel members and passes between the parallel members to separate the parallel members at the location of the visible mark.

8. A re-usable tamper-indicator device according to claim 1, wherein the separating means is operable to separate the parallel members when the device is removed from the item.

9. A re-usable tamper-indicator device according to claim 1, wherein the item is a container and the device is integral with a closure member of the item.

10. A re-usable tamper-indicator device according to claim 1, wherein the item is a container and the device is independent of the closure member of the item.

11. A re-usable tamper-indicator device according to claim 1, wherein the item is movable between an open and a closed configuration and wherein the separating means is operable to separate the parallel members when the device is moved from the closed configuration to the open configuration.

12. A re-usable tamper-indicator device according to claim 1, wherein the means for causing relative movement of the parallel members comprises an engagement portion for engaging with a container, the engagement portion operable to be moved between an engaged position and an un-engaged position to cause relative movement of the parallel members such that at least a portion of the visible mark is erased.

13. A re-usable tamper-indicator device according to claim 1, further comprising means to prevent the at least two substantially parallel members from being brought into contact with one another under pressure after the substantially parallel members have moved relative to one another.

14. A method of applying a tamper-indication to an item, the method comprising the steps of:
a. providing a tamper-indicator device comprising at least two substantially parallel members which produce a visible mark when brought into contact with one another under pressure, and a means for causing relative movement of the parallel members such that at least a portion of the visible mark is erased;
b. applying the device to an item; and
c. applying a mark to the device by bringing the two parallel members together under pressure.

15. A method of detecting if an item comprising the device of claim 1 has been tampered with, said method of detecting comprising checking if the mark is present on the device, wherein the absence of the mark indicates that tampering has taken place.

16. A method according to claim 15, wherein the presence of the mark indicates that no tampering has taken place.

17. A container comprising a tamper-indicator device according to claim 1.

18. A security stamp for use with a tamper-indicator device according to claim 1, said stamp comprising a defined pattern provided in relief for use in the application of pressure to the surface of the device.

19. (canceled)

20. (canceled)

21. (canceled)

22. (canceled)
